(19) United States
(12) Patent Application Publication
(10) Pub. No.: US 2005/0050193 A1
(43) Pub. Date: Mar. 3, 2005

(54) Use of a policy-based network management system for centralised control of the enforcement of policy rules

(75) Inventors: Maurice Edwiges, St Pierre Du Perray (FR); Arnaud Gonguet, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/927,031

(22) Filed: Aug. 27, 2004

(30) Foreign Application Priority Data
Aug. 29, 2003 (FR) 03 10 283

(51) Int. Cl. G06F 15/173

(52) U.S. Cl. 709/223

(57) ABSTRACT

A network equipment management system (EMS) for a network management system (NMS) of a communication network, including a multiplicity of network equipments (NE) handled by policy rules associated with services, includes processing means (MT) arranged, when it receives a request to check the enforcement of a set of policy rules associated with a service, to determine information data representing this set, and then to look for these information data in at least one managed equipment equipment (NE) of the said network, concerned by the said set.

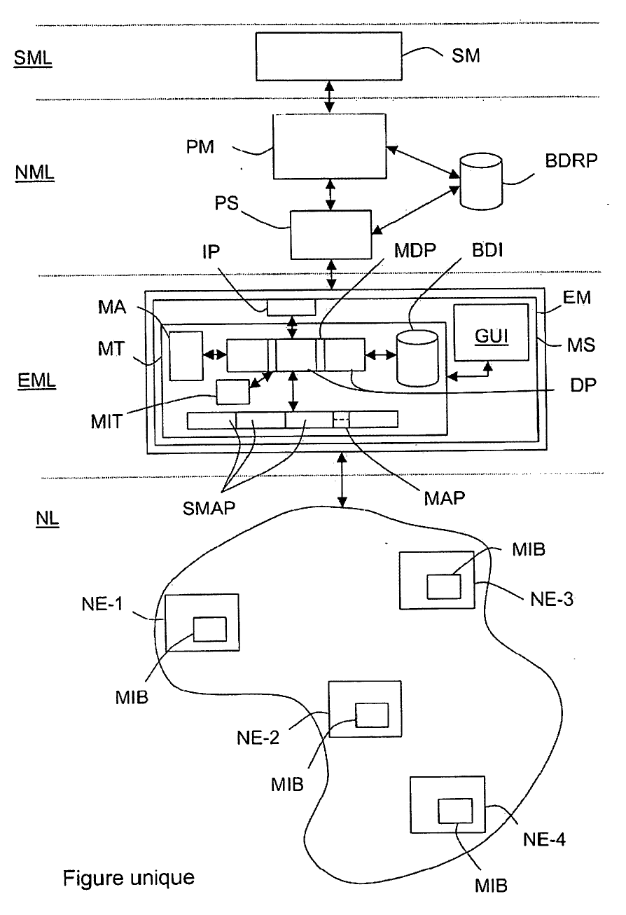

### BACKGROUND OF THE INVENTION

The invention concerns communication networks in which the network equipment (or elements) are handled in accordance with a policy defined by policy rules.

Here, a “policy rule” is a rule of the “if<condition> then <action>” type. These policy rules determine the processing of traffic, associated with services, that the network equipment must perform. They are prepared by the operator (or the supervisor) of the network in accordance with the equipment of which it is composed, and with service level agreements (SLAs) made with his customers.

In addition, here again, “network equipment” refers to any type of hardware, such as servers, terminals, switches, routers or concentrators, capable of exchanging data, and management data in particular, in accordance with a network management protocol, with the network management system of the network to which it belongs. The network management protocol can be the RFC 2571-2580 simple network management protocol (SNMP) for example, as used in particular in networks of the ADSL type, the TL1 protocol used in particular in networks of the SONET type, the Q3 protocol used in particular in networks of the SDH type, or the CLI and CORBA protocols.

Here again, a “network element” or network equipment element refers to any component of a network that is capable of performing at least one traffic process, such as a card, an interface, a shelf, or a rack. Such a network element can be defined by one or more capabilities which determine its ability to perform a function within the network, such as making up packets of data, converting network addresses, or performing a specific process.

Finally, here “traffic” refers to both a stream of data packets and a single packet of data.

In the above-mentioned networks, the policy rules associated with a service are transmitted in the form of configuration commands to the network equipments (or elements) concerned, so that they configure themselves as a consequence, in order to allow the enforcement of the service. Now there is no known mechanism that can be used to check or verify, automatically and directly, whether or not the network equipment is configured correctly following the transmission of policy rules, or indeed whether or not they already possess a particular configuration.

There are only two indirect techniques that can be used to perform such a check or verification. One of these techniques consists of using what the man skilled-in-the-art describes as a “craft terminal” (meaning a terminal dedicated to local management of equipment) to enter all the configuration commands corresponding to policy rules, and then to view whether the equipment elements are configured correctly. The other technique consists of using a graphical interface of the graphical user interface (GUI) type, installed at the level of the element management layer (EML) of the network management system (NMS), so as to view whether the equipment are correctly configured.

These techniques are not entirely satisfactory because they require the establishment of many sessions (or connections) with the network equipment, thereby consuming network resources. Furthermore, at least one of these techniques results in an increase in the time and the cost of network maintenance.

A third technique, which goes with the second, consists of automating verification of the equipment configuration, by retrieving the configuration of elements, and then comparing these configurations with the policy rules that have been sent to them. Such a method, for example, was described in American patent applications US 2002/0178380 and US 2002/0069274. Nevertheless, this is a solution that is difficult to implement, since one has to be able to compare an equipment configuration with policy rules. This task can prove to be difficult for the server responsible for executing it. Then, as in the previous approach, it necessitates many connections to the equipment, and significantly increases the network traffic as the configurations are retrieved from the various equipment elements.

The aim of the invention is therefore to improve this situation.

To this end, it proposes a network equipment management system (EMS), for a network management system (NMS) in a communication network.

This network equipment management system is characterized by the fact that it includes processing means (or module), arranged, when they receive a request to check the enforcement of a set of at least one policy rule associated with a service, to determine information data representing this set, and then to look for these information data in at least one of the managed equipments of the network, concerned by the policy-rule set.

The network equipment management system (EMS) according to the invention can include other characteristics that can be taken separately or together, and in particular:
a first memory storing a table of correspondence between service identifiers, associated with sets of policy rules, and information data. In this case, the processing means are arranged, when they receive an request to check the inforcement including a service identifier, to determine, in the table, the information data which correspond to the service identifier contained in the received request, so as to perform the search,
a table which is also capable of storing network equipment identifiers in correspondence with the set identifiers. In this case, the processing means are arranged, when they receive a request to check the enforcement, to perform the search for information data in at least one of the equipments whose identifier is stored in the table of the first memory that corresponds to the service identifier contained in the received request,
processing means, arranged, when they receive a request to check the enforcement including at least one network equipment identifier, to perform the search for information data in each equipment whose identifier is contained in the received request,
processing means which include a second memory in which policy descriptors, each associated with a service identifier, are stored. Each policy descriptor is arranged, firstly, to be loaded, following the receipt of a request to check the enforcement including at least the service identifier associated with it, so as to access the first memory in order to extract from it the information data which are stored there and that correspond to the service identifier, and secondly, to generate instructions dedicated to the information data sought in at least one managed equipment of the network,
processing means which include protocol adaptation means coupled to the policy descriptors and arranged to convert the search instructions into search commands, of the CLI type or the SNMP type for example, so that they are transmitted to each equipment concerned in accordance with its management protocol.
policy descriptors, arranged, when they receive a response message transmitted by an equipment, following the receipt of a search command, to compare the searched-for information data with the information data contained in the response message, and to generate a report message representing the result of this comparison.

The invention also proposes a management server equipped with an equipment management system (EMS) of the type presented above.

The invention also proposes a process to control the enforcement of policy rules, associated with services, in the managed equipment of a communication network.

This process is characterized by the fact that it consists, in the event of an request to check the enforcement of a set of at least one policy rule associated with a service, of determining information data representing the set, and then looking for the information data in at least one managed equipment of the network concerned by this policy-rule set.

The invention is particularly well suited, though non-exclusively, to communication networks such as transmission networks (of the WDM, SONET and SDH type, for example), data networks (of the Internet-IP or ATM type, for example), speech networks (of the conventional or mobile type, for example) or mixed speech-data networks (of the NGN type, for example). In addition, the invention can be used to control of many types of network equipment, and in particular base stations (or gateways) for satellite transmission.

Other characteristics and advantages of the invention will appear on examining the following detailed description, and the appended drawing, in which the single FIGURE schematically illustrates an example of a communication network equipped with an equipment management system (EMS) according to the invention, installed in a management server (MS).

The appended drawings can not only serve to complete the invention, but also contribute to its specification, as appropriate.

The purpose of the invention is to provide control of the enforcement of policy rules in the equipment (or elements) of a communication network.

It is considered in what follows, by way of an illustrative example, that the communication network is at least partially of the Internet (IP) type. However the invention also applies to other types of network, such as transmission networks of the WDM, SONET or SDH type, data networks of the ATM type, or speech networks of the conventional or mobile type, or indeed to mixed speech-data networks such those of the NGN type.

As illustrated in the single FIGURE, a communication network of the managed type can be broken down schematically into four layers: a first layer called a service management layer (SML), a second layer coupled to the SML layer and called a network management layer (NML), a third layer coupled to the NML layer and called an element management layer (EML), and a fourth layer coupled to the EML layer and called a network layer (NL).

The first (SML), second (NML) and third (EML) layers define, at least in part, the management system of the network which is intended to enable the manager (or supervisor) of the network to manage and remotely control the managed network equipment (NE-I) to which it is coupled.

The fourth layer (NL) includes a large amount of network equipment (NE-i where i=1 to 4, but it can take any value) composed of at least one network element and connected to each other by communication means.

Each network equipment (NE-i) is capable of exchanging management data with the management system (NMS), in accordance with a chosen management protocol such as the SNMP protocol or the TL1, CORBA, CLI or Q3 protocols. A network equipment (NE-i) can, for example, be a peripheral or core server, a terminal, a switch, a router, a concentrator, or a base station (or a gateway) for satellite transmission. In addition, a network element is a component of a network equipment (NE-i) capable of performing at least one traffic process. It can be a card, an interface, a shelf, or a rack, for example. Once configured, a network element is arranged to perform a function within the network, such as preparing packets of data, converting network addresses, or performing processing of the BGP/MPLS VPN SAP (Service Access Point) type.

The first SML layer is composed of a service manager (SM) arranged to translate service level agreements (SLA), made between the operator of the network and its customers, into policy rules.

These policy rules define, by group, policies that have been prepared by the operator so as to satisfy the service level agreements (SLA). They are intended to determine the traffic processing (or functions) that the different managed network equipments (NE-i) and their network elements must perform, once configured, in order to implement the services offered by the network, such as a service of the virtual private network (VPN IP) type.

The second NML layer is composed of policy manager (PM), supplied with policy rules by the service manager (SM), and of one or more policy servers (PS) coupled to the policy manager (PM).

The policy manager (PM) mainly allows the administrator of the network, or its operator, to associate roles with policy rules. Each policy server (PS) is arranged to validate the policy rules that it receives from the policy manager (PM), to store them in a policy-rules memory (BDR), and to transmit them selectively to the third EML layer.

Since each service is defined by a set of at least one policy rule which has to be instituted by one or more equipments (NE-i) in the network, then the policy-rules memory (BDR) preferably includes a table of correspondence between service identifiers and sets of policy rules.

For example, service identifier 204 is associated with the service rule called “Create VRF” and defined by “if true then set the VRF to VRF1”. This policy rule indicates that it is necessary to create a VRF bearing the name “VRF1”.

The third EML layer is composed of one or more element management modules (EM) arranged to provide the dialogue interface between the network management system (NMS), and in particular its first (SML) and second (NML) layers, and the equipments (NE-i) of the network to which they are respectively coupled. For example, each element management module (EM) is installed in a management server.

In the example illustrated in the single FIGURE, only a single policy server (PS) and a single element management system (EMS) have been shown. However the network management system (NMS) can include several policy servers (PS) coupled to the policy manager (PM), and each policy server (PS) can be coupled to several element management systems (EMS).

As shown above, the equipment management system (EMS) according to the invention is conventionally arranged to get the interfaces of the network (and in particular those of the equipment) to talk to each other, and to manage the alarms and the events that are triggered or that occur within the network equipments (NE-i).

To this end, it includes a processing module (MT) coupled, firstly, to a policy server (PS) of the second NML layer, preferably via a policy interface (IP), and secondly, to some equipments (NE-i) in the network.

The processing module (MT) includes firstly a management information tree (MIT) and a descriptor memory (MDP), in which policy descriptors (DP) are stored.

A policy descriptor (DP) is a computer module which contains all the data necessary for the management, by the equipment management system (EMS), of one aspect of at least one equipment (NE-i), corresponding to a set of policy rules. A policy descriptor (DP) is based on an internal object model describing one aspect of an equipment (NE-i).

A policy descriptor (DP) is therefore a computer module not only capable of supplying to the network equipment (NE-i) for which it is responsible, the instructions which allow it to be configured in accordance with sets of policy rules, in such a way that they institute all or part of the services associated with these sets, but also capable of determining, in the said network equipment (NE-i), information data that represent their respective configurations corresponding to the said sets.

A policy descriptor (DP) can also include all or part of the information associated with one or more equipments and defining their respective states, and in particular the exchange (or management) protocols that they use.

Each policy descriptor (DP) is generally composed of at least one first program-code file used to dialogue with an equipment interface, a second file containing data which designate at least one type of equipment (NE-i), and a third file containing data which designate a management information base (MIB) definition, associated with the equipment (NE-i) of the type concerned, and with at least one configuration file, of the XML type for example, which contains information used to manage one type of equipment in the network. The program-code files of the policy descriptors (DP) are preferably in the Java language, because of the ability of this language to load and unload computer code dynamically. However other languages, such as Small Talk, can also be envisaged, on condition that they allow the dynamic loading and unloading of computer code.

Due to these policy descriptors (DP), the processing module (MT) is capable of checking or verifying the enforcement of a set of policy rules in one or more network equipments (NE-i). This check is effected at the request of the operator (or of the administrator) of the network by means of a request to check the enforcement of a set of at least one policy rule associated with a service. This request can be transmitted to the processing module (MT) either by the policy manager (PM), via the policy server (PS), or by a graphical interface module (GUI) installed in the equipment management system (EMS) or located remotely in the network management system (NMS).

More precisely, when the processing module (MT) receives a request to check the enforcement of a set of at least one policy rule associated with a service, it determines the information data representing this set, and then it searches for these information data in at least one of the managed equipments (NE-i) in the network, concerned by the set.

This determination of information data is effected preferably by the interrogation of a memory (BDI) of the processing module (MT), coupled to the descriptor memory (BDP), and in which a table of correspondence between service identifiers, associated with sets of policy rules and information data, is stored.

The information data are, for example, textual portions of the policy rules stored in the rules memory (BDRP), and representing their enforcement by an equipment (NE-i). In the aforementioned example of the VRF service, the information data characteristics are “IP VRF VRF1” for example. These information data are therefore stored in the table of the memory (BDI) that corresponds to service identifier 204.

The information data and the service identifiers can also be stored, where appropriate, in correspondence with the network identifiers of the equipments (NE-i) concerned. In a variant, the policy descriptors (DP) can include the (network) identifiers of the equipments (NE-i) concerned. Thus, when the processing module (MT) receives a request to check the enforcement, it transmits it to an analysis module (MA) included within it, charged to determine the policy descriptor (DP) associated with the service identifier that it contains. The analysis module (MA) then loads (or activates) the policy descriptor (DP) that it has just determined, so that it can access the memory (BDI) in order to determine the information data therein, as well, where appropriate, as the equipment identifier(s) stored in the table that corresponds to the service identifier. Once in possession of the information data and of the equipment identifier(s), the loaded policy descriptor (DP) can initiate the search for the said information data in the identified equipment(s).

In the absence of equipment identifiers in the memory (BDI), each equipment identifier, the subject of a search for information data, must be contained in the request to check the enforcement, transmitted to the processing module (MT). As a consequence, the loaded policy descriptor (DP) extracts from the memory (BDI) only the stored information data that corresponds to the service identifier contained in the received request, and then performs its search in each equipment (NE-i) designated in the received request. To initiate the information data search, the loaded policy descriptor (DP) generates search instructions containing the information data looked for, and that it has just extracted from the memory (BDI).

The managed network equipment (NE-i) is able to use different management protocols, of the command line interface (CLI) or SNMP type for example, and the search instructions must therefore be converted into search commands that are suitable for their respective management protocols.

This conversion is preferably performed by a protocol adaptation module (MAP) included in the processing module (MT) (but which may also not be so, but rather forming part of the equipment management system (EMS)). As the professional engineer knows, certain equipment management systems (EMS) are in fact equipped with a protocol adaptation module (MAP) that includes submodules (SMAP) at least equal in number to the number of management protocols used by the different network equipments (NE-i) that they manage.

Each protocol adaptation submodule (SMAP) is arranged to transform, by order, instructions, in particular of the search type, intended for an equipment (NE-i), in commands which are in the format of the management protocol used by this equipment.

As indicated previously, the loaded policy descriptor (DP) generally knows the protocols used by the network equipments (NE-i) in which the search for information data must be effected. As a consequence, once it has determined the instructions intended for a selected network equipments (NE-i), it determines the management protocol of this equipment (NE-i), and then deduces from this the protocol adaptation submodule (SMAP) which corresponds to it. It then transmits the instructions to be transformed (or converted) to this protocol adaptation submodule (SMAP), in commands that accord with the management (or exchange) protocol used by the equipment (NE-i).

For example, a search command in the CLI format comes in the form “Show IP VRF VRF1”. In this particular example, the CLI command is designed to ask an equipment (NE-i) if the value of its configuration parameter (VRF) is equal to VRF1.

Once the search commands have been generated, the protocol adaptation submodule (SMAP) transmits them to the equipment (NE-i) concerned, in a conventional manner.

When a network equipment (NE-i) receives a search command, it processes it, and then sends back to the management system (NMS), and more precisely to the equipment management system (EMS) with which it is associated, a response message containing either the information data looked for, if it has it, or warning data indicating that it does not have the information data sought.

This response message is then transmitted to the policy descriptor (DP) that initiated the search, so that it can compare the information data sought with the information data that it contains. Once the comparison has ended, the policy descriptor (DP) generates a report message intended for the module of the management system (NMS) which had generated the request to check the enforcement. The report can then be displayed on a screen by means of a graphical interface module (GUI).

The equipment management system (EMS) according to the invention, and in particular its processing module (MT), can be implemented in the form of electronic circuits, software (computer) modules, or a combination of circuits and software.

By virtue of the invention, it is now possible to check or verify, remotely, in an automated manner, and without resorting to individual connections and/or to third-party equipment such “craft terminals”, whether or not a network equipment is configured in accordance with selected policy rules. It is important to note that this check can be used to verify that policy rules have been correctly taken into account by one or more network equipment, or in other words that equipments are correctly configured in the light of the policy rules which have been transmitted to them, but also to determine if network equipments have not already been configured in the light of policy rules.

The invention also offers a process to check the enforcement of policy rules, associated with services, in managed equipments (NE-i) of a communication network.

In particular, this can be implemented by means of the equipment management system (EMS) presented above. Since the main and optional functions and subfunctions performed by the stages of this process are more or less identical to those performed by the different means making up the equipment management system (EMS), only those stages that implement the main functions of the process according to the invention will be summarized below.

This process consists, in the case of a request to check the enforcement of a set of at least one policy rule associated with a service, of determining information data representing the set, and then looking for the information data in at least one managed equipment (NE-i) in the network, concerned by this set.

The invention is not limited to the methods of implementation of the equipment management system (EMS), of the management server (MS) and of the checking process described above only by way of an example, but it also covers all the variants which can be envisaged by the professional engineer in the context of the following claims.

1. A network equipment management system (EMS), for a network management system (NMS) of a communication network, including a multiplicity of network equipments (NE) handled by policy rules associated with services, characterized in that it includes processing means (MT) arranged, in the event of receiving a request to check the enforcement of a set of at least one policy rule associated with a service, to determine information data representing the said set, and then to look for the said information data in at least one managed equipment (NE) of the said network, concerned by the said set.

2. A system according to claim 1, characterized in that it includes a first memory (BDI) storing a table of correspondence between service identifiers, associated with sets of policy rules, and information data, and in that the said processing means (MT) are arranged, in the event of receiving a request to check the enforcement including a service identifier, to determine, in the said table, the information data corresponding to the service identifier contained in the received request, so as to perform the said search.

3. A system according to claim 2, characterized in that the said first memory (BDI) stores network equipment (NE) identifiers in the said table in correspondence with the set identifiers.

4. A system according to claim 3, characterized in that the said processing means (MT) are arranged, in the event of receiving a request to check the enforcement, to perform the said search for information data in at least one of the network equipments (NE) whose identifier is stored in the table of the said first memory (BDI) that corresponds to the service identifier contained in the said received request.

5. A system according to claim 1, characterized in that the said processing means (MT) are arranged, in the event of receiving a request to check the enforcement including at least one network equipment identifier (NE), to perform the search for information data in each network equipment (NE) whose identifier is contained in the said received request.

6. A system according to claim 2, characterized in that the said processing means (MT) include a second memory (MDP) in which are stored policy descriptors (DP), each associated with a service identifier and each ready i) to be loaded, following the receipt of a request to check the enforcement including at least their respective service identifier, so as to access the said first memory (BDI) in order to extract from it the information data stored in correspondence with the said service identifier, and ii) to generate instructions dedicated to the search for the said information data in at least one equipment (NE) of the said network.

7. A system according to claim 6, characterized in that the said policy descriptors (DP) include network equipment (NE-i). identifiers

8. A system according to claim 6, characterized in that the said processing means (MT) include protocol adaptation means (MAP) coupled to the said policy descriptors (DP) and arranged to convert instructions into search commands so that they can be transmitted to each network equipment (NE) concerned, according to the management protocol that it employs.

9. A system according to claim 8, characterized in that the said search commands are chosen from a group that includes at least commands of the CLI and SNMP types.

10. A system according to claim 6, characterized in that the said policy descriptors (DP) are arranged, on receipt of a response message transmitted by a network equipment (NE) following the receipt of a search command, to compare the said searched-for information data with the said information data contained in the said response message, and to generate a report message representing the result of the said comparison.

11. A management server (MS) of a network management system (NMS), characterized in that it includes an equipment management system (EMS) according to claim 1.

12. A process to check the enforcement of policy rules, associated with services, in managed equipment (NE) in a communication network, characterized in that it consists, in the event of a request to check the enforcement of a set of at least one policy rule associated with a service, of determining information data representing the said set, and then looking for the said information data in at least one managed equipment (NE) of the said network, concerned by the said set.
